(19) United States
(12) Patent Application Publication
(10) Pub. No.: US 2007/0132313 A1
(43) Pub. Date: Jun. 14, 2007

(54) Device for the voltage supply in a motor vehicle

(76) Inventor: Michael Baeuerle, Ditzingen-Heimerdingen (DE)

Correspondence Address: KENYON & KENYON LLP, ONE BROADWAY, NEW YORK, NY, 10004, US

(21) Appl. No.: 10/553,510

(22) PCT Filed: Apr. 10, 2004
(86) PCT No.: PCT/DE04/00753

§ 371 Date: Jul. 12, 2006

(30) Foreign Application Priority Data
May 12, 2003 (DE) 103 21 155.1

(51) Int. Cl. B60L 1/00

(52) U.S. Cl. 307/10.1

(57) ABSTRACT

A device for the voltage supply for a heavy power consumer, e.g., an electric auxiliary compressor in a motor vehicle, in which the electric auxiliary compressor is supplied with voltage with the aid of two ultracaps and one high current diode. The voltage supply via the high current diode takes place starting from the battery of the vehicle electrical system, while the ultracaps provide high electric power for a short time during the starting phase of the electric auxiliary compressor at a voltage level which is doubled vis-a-vis the voltage level of the vehicle electrical system.

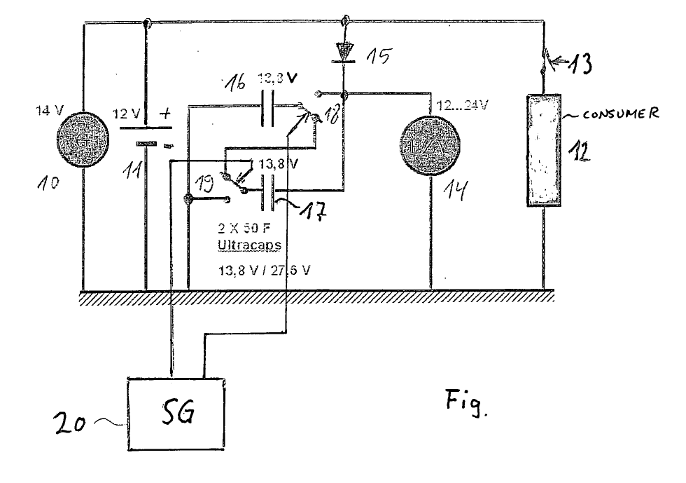

### FIELD OF THE INVENTION

The present invention relates to a device for the voltage supply in a motor vehicle.

### BACKGROUND INFORMATION

The voltage supply for power-consuming components in a motor vehicle is generally provided by a battery chargeable by a generator. In modern motor vehicles having a plurality of power-consuming components, one voltage storage device or one battery is often insufficient for the voltage supply, so that two separate voltage storage devices are used which are connected either in series with each other or in parallel. A voltage supply system in a motor vehicle which has two voltage storage devices is described, e.g., in published German patent document DE 41 38 943, for example. Problematic in all voltage supply systems in a motor vehicle is the operation of heavy power consumers. Connecting such heavy power consumers may result in a voltage drop in the vehicle electrical system, causing unacceptable minimum voltages. Therefore, different measures are described, e.g., in published German patent document DE 41 38 943, which make it possible to minimize a voltage drop during connection of a heavy power consumer, at least in certain parts of the vehicle electrical system. The starter is cited as an example of a heavy power consumer whose operation during the starting process, i.e., at times at which the generator does not yet provide a power output, results in a voltage drop.

A separate battery is assigned to the starter for reducing this voltage drop; in addition, it is decoupled from the remaining electrical system during the starting process via a switch. Additional stabilization is achieved due to the fact that, in addition to the starter battery, two further batteries are switched in series with each other, the negative pole of the starter battery, the negative pole of a first battery, and the positive pole of a second battery being connected together to ground in this case. Such voltage supply systems ensure that no impermissible voltage drops occur during the starting process, at least in certain areas of the vehicle electrical system.

In addition to the starter, other heavy power consumers also exist in a modern vehicle electrical system, e.g., for the electric brake, the electrohydraulic brake (EHB), for an electric power steering system (EPS), or an electric auxiliary compressor (EAC). Vehicle electrical systems which contain such consumers need special designs or architectures, in order to adequately meet the increased loads. These vehicle electrical systems normally have a nominal voltage of 12 V in passenger vehicles and 24 V in commercial vehicles; however, electrical systems having 42 V are also considered. The voltage increase has the advantage that lower currents flow with the same electric power, so that the cable cross sections may be reduced; however, voltage drops that occur when heavy power consumers are connected are not prevented to the desired extent. Moreover, in vehicle electrical systems having elevated voltages at least in a partial area, d.c.-d.c. converters or a reactor are required, with the aid of which suitable voltage conversions may be executed. Such approaches, however, are quite complex and incur undesirably high costs.

In addition to using batteries as electric energy storage devices, special capacitors, known as supercaps or ultracaps, may be used These capacitors are relatively lightweight and are able to be charged quickly; they supply their power, however, only by tolerating a significant voltage drop. In contrast to batteries, the characteristic curve U=f(Q) in capacitors steadily falls linearly, i.e., such energy storage devices live on voltage drops. Shunting a supercap to a battery would thus, by itself, not solve the problem of a voltage drop, since the available voltage range of 0.5 V stresses the supercap only by approximately 7% with respect to the stored energy. In order to generate significant effects, very large capacitances would be required in a shunt connection. Such an approach would therefore not be practical, for cost and for weight reasons.

Separating the capacitor or the second battery from the remaining electrical system with the aim of being able to tolerate a greater voltage drop is indeed possible, but it requires an expensive d.c.-d.c. converter for charging the capacitor or the second battery, and for providing the steady-state power.

### SUMMARY

The device according to the present invention for the voltage supply in a motor vehicle has the advantage over the related art in that the voltage drops, which occur during the connection of heavy power consumers, are only very minor, no second battery being required for achieving this advantage. This advantage is achieved with the aid of a very cost-effective voltage supply circuit which, due to the minimal voltage drop, prolongs the service life of all components of the vehicle electrical system which need a constant voltage when a heavy power consumer is connected. It is particularly advantageous that the approach according to the present invention results in only a minimal weight increase in contrast to conventional systems.

The present invention provides combining the conventional 12 Volt electrical system architecture with small high performance capacitors for stabilizing the starting phase of the heavy power consumer, e.g., the electric auxiliary compressor EAC. It is particularly advantageous that this approach makes it possible to provide 100% of the starting current from the capacitor (supercap) and to take over 100% of the steady-state current from the conventional electrical system. With respect to the service life, the supercaps having the required high current pulses have significantly better values than conventional batteries. This makes it possible to increase the service life of the entire system in an advantageous manner.

Example embodiments according to the present invention include systems in which two supercaps or ultracaps having a 50 F capacitance each are used, supplemented by a generator gain of approximately 30 A. A voltage regulator having a quick load response function and/or a control unit having two electronic switches and one high current diode may be used in an advantageous manner.

Using the device according to the present invention for the voltage supply in a motor vehicle yields the advantages with respect to stabilizing the voltage drop (0.5 V) without a heavyweight second battery and/or without expensive d.c.-d.c. converters.

### BRIEF DESCRIPTION OF THE DRAWING

The FIGURE shows a circuit diagram illustrating a device for the voltage supply according to the present invention.

### DETAILED DESCRIPTION

The components of a vehicle electrical system essential for understanding the present invention are illustrated in the Figure. In detail, reference numeral 10 indicates a generator which is regulated, via a voltage regulator (not shown), in such a way that it provides a rectified voltage of approximately 14 V at its output. Battery 11 having a 12 V nominal voltage is positioned parallel to generator 10. The remaining consumers of the electrical system are indicated by reference numeral 12. Consumers 12 include a plurality of power-consuming components in the vehicle electrical system which are either constantly connected to battery 11 or are temporarily connectable to battery 11 with the aid of suitably activatable switches 13.

A heavy power consumer, e.g., an electric auxiliary compressor 14, which may be designed for voltages of 12 Volt to 24 Volt, is connected to the positive pole of battery 11 or to the output of generator 10 via a diode 15. Diode 15 is situated in such a way that its anode is connected to the positive pole of battery 11 and its cathode is connected to the heavy power consumer, e.g., electric auxiliary compressor 14. This makes it possible to supply electric auxiliary compressor 14 from the battery via conducting diode 15.

Two charge storage devices, e.g., two ultracaps 16, 17, together with two switches 18, 19 form a circuit configuration which is connectable to electric auxiliary compressor 14 under certain conditions. Ultracaps 16, 17 are designed for 13.8 V, for example, and have a capacitance of 50 F each.

The vehicle electrical system architecture for operating electric auxiliary compressor 14 functions as follows:

For charging when the electric auxiliary compressor is inactive, the two supercaps or ultracaps 16, 17 are charged parallel to the conventional 12 Volt electrical system, i.e., the two charge storage devices are connected to generator 10 or battery 11. This is carried out by correspondingly activating switches 18 and 19. During activation of the electric auxiliary compressor, a series connection of the two supercaps 16, 17 is established via a control unit 20 using the two high current switches 18, 19, so that the voltage for supplying the electric auxiliary compressor is doubled.

The voltage drop during the ramp-up phase of the electric auxiliary compressor starts at 27.6 V in the above-described circuit configuration, so that together with the supercap circuit, decoupled by high current diode 15, no voltage drop occurs in the 12 Volt system. Discharging of supercaps 16, 17 takes place very efficiently with an available voltage range from 27.6 Volt to 13.8 Volt and a corresponding power consumption of approximately 75%. Only after transition into the steady-state phase of the electric auxiliary compressor, which is operated with approximately half the current, does a soft transition to the 12 Volt vehicle electrical system take place. Here also, supercaps 16, 17 remain in operation in a supporting manner. If a voltage regulator having a quick load response characteristic is assigned to generator 10 as the voltage regulator, this voltage regulator supports the stabilization of the voltage drop during the transition to steady-state operation.

After the activation of electric auxiliary compressor 14 is completed, the series connection is, for recharging both supercaps 16 and 17, reconverted into the parallel connection of the supercaps with the 12 Volt vehicle electrical system, e.g., in two steps, by consecutively operating both switches 18, 19. Using the circuit illustrated in the figure, no expensive d.c.-d.c. converter is necessary for recharging the two supercaps. As a result of the efficient utilization of both supercaps, relatively small supercaps of the order of magnitude of 2×50 F are sufficient. Switching transistors, relays, or other suitable switches may be used as switches.

In an alternative embodiment, a linearly regulated or electronically controlled additional switch may be used instead of high current diode 15. Control of the individual switches may be executed with the aid of a separate control unit or by the engine controller (motronic), by a control unit for the electrical system or a separate EAC control unit.

In general, the two charge storage devices 16 and 17 are connected in series when heavy power consumer 14 is activated, and operated in parallel connection when the heavy power consumer is deactivated, i.e., when the ramp-up phase of the heavy power consumer is completed. Switching from the parallel connection to the series connection may take place in at least two steps or continuously, i.e., in a single step.

1-10. (canceled)

11. A device for supplying voltage to a heavy power consumer in a motor vehicle, comprising:
a generator that provides a controlled DC voltage for charging a battery and for supplying at least one consumer;
a circuit arrangement for connecting the heavy power consumer to one of the battery and the generator, wherein the circuit arrangement includes a first electronic component that is situated between the positive pole of the battery and the heavy power consumer, and at least two charge storage devices that are selectively connected to one another by a switching arrangement, and wherein the at least two charge storage devices are selectively connected to the heavy power consumer and the electronic component; and
a control device for controlling the operation of the switching arrangement.

12. The device as recited in claim 11, wherein the at least two charge storage devices are connected in series by selected switching of the switching arrangement by the control device when the heavy power consumer is activated, and wherein the switching arrangement includes two switches.

13. The device as recited in claim 12, wherein the at least two charge storage devices are connected in parallel by selected switching of the switching arrangement by the control device when one of: a) the heavy power consumer is deactivated; and b) a starting process of the heavy power consumer is completed.

14. The device as recited in claim 13, wherein a transition from the series connection to the parallel connection of the at least two charge storage devices occurs in at least two steps.

15. The device as recited in claim 13, wherein a transition from the series connection to the parallel connection of the at least two charge storage devices takes place in a single continuous step.

16. The device as recited in claim 11, wherein the heavy power consumer is one of an electric auxiliary compressor, a piezoelectric actuator, an electro-hydraulic brake, and an electric power steering system.

17. The device as recited in claim 13, wherein the at least two charge storage devices are super capacitors.

18. The device as recited in claim 13, wherein the electronic component is one of a high current diode, an electronically controlled switch, and a linearly regulated switch.

19. The device as recited in claim 13, wherein the control device is one of a control unit for the vehicle electrical system, an engine controller, and a control unit for an electric auxiliary compressor, and wherein the control device outputs triggering signals for operating the individual switches.

20. A method for supplying voltage to a heavy power consumer in a motor vehicle, comprising:
providing, using a generator, a controlled DC voltage for charging a battery and for supplying at least one consumer;
selectively connecting, by a circuit arrangement, the heavy power consumer to one of the battery and the generator, wherein the circuit arrangement includes a first electronic component that is situated between the positive pole of the battery and the heavy power consumer, and at least two charge storage devices that are selectively connected to one another by a switching arrangement, and wherein the at least two charge storage devices are selectively connected to the heavy power consumer and the electronic component; and
controlling, using a control device, the operation of the switching arrangement, wherein the control device detects when the heavy power consumer is to be connected, and wherein the control device subsequently outputs appropriate triggering signals to the switching arrangement to ensure a required voltage supply for the heavy power consumer.
